(19) United States
(12) Patent Application Publication
(10) Pub. No.: US 2025/0356187 A1
(43) Pub. Date: Nov. 20, 2025

(54) APPARATUS AND METHODS FOR A NO-CODE GRAPHICAL USER INTERFACE TO DEFINE A SYSTEM TO COLLECT UNSTRUCTURED DATA USING GENERATIVE ARTIFICIAL INTELLIGENCE (AI)

(71) Applicant: NLX Inc., New York, NY (US)

(72) Inventors: Andrei PAPANCEA, New York, NY (US); Samuel TROST, Walnut Cove, NC (US)

(73) Assignee: NLX Inc., New York, NY (US)

(21) Appl. No.: 18/985,972

(22) Filed: Dec. 18, 2024

Related U.S. Application Data
(60) Provisional application No. 63/649,567, filed on May 20, 2024.

(51) Int. Cl. G06N 3/08

(52) U.S. Cl. CPC G06N 3/08

(57) ABSTRACT

In an embodiment, the following are repeated during a session with a user compute device. A message is received from the user compute device. A determination is made as to whether a workflow portion from a plurality of workflow portions is structured or unstructured. The workflow portion is executed as structured based on the message when the workflow portion is determined to be structured, to produce a structured response. The workflow portion is executed as unstructured based on the message, a task description and a list of structured parameters to be captured, when the workflow portion is determined to be unstructured, to produce an unstructured response via a generative artificial intelligence model.

### CROSS-REFERENCE TO RELATED PATENT APPLICATIONS

The present application claims priority to U.S. provisional patent application Ser. No. 63/649,567, filed on May 20, 2024 and titled “Apparatus and Methods for Unstructured Data Collection for Driving Structured Workflows,” the contents of which is incorporate herein by reference in its entirety.

### FIELD

The present disclosure relates to the collection of unstructured data using generative artificial intelligence (AI) to facilitate the generation of structured workflows in a no-code user interface.

### BACKGROUND

Capturing structured information from free-form human conversation is difficult. Humans oftentimes provide input to structured questions in a very unstructured, free-flowing way, which makes it difficult for the computer to capture with known Natural Language Processing (NLP) techniques (e.g., slot/entity detection/extraction). In other words, building structured conversation flows for capturing free-form human inputs is challenging because of the large number of permutations of how humans might respond (e.g., Bot: “Would you like to reschedule your appointment in the morning or afternoon?”, Human: “How about next Friday at 10 am?”). In short, human language contains a lot of ambiguity.

Known solutions typically involve developing complex software applications to drive specific use cases. It is time-consuming, however, to build and maintain deterministic conversation flows that are comprehensive enough to capture the variability of human answers to structured questions. More specifically, known solutions typically require meaningful software engineering efforts and rely on largely deterministic workflows that are difficult to maintain given the arguably infinite permutations of human input.

While large language models can be leveraged and the resulting generative artificial intelligence (AI) text output of such large language models can carry unscripted conversations between humans and an AI system, the resulting output of the conversation is unstructured and non-deterministic, which typically makes the resulting output unfit for driving business processes, which are typically structured.

Thus, a need exists for improved methods and apparatus for capturing structured information from free-form human conversation.

### SUMMARY

In an embodiment, the following are repeated during a session with a user compute device. A message is received from the user compute device. A determination is made as to whether a workflow portion from a plurality of workflow portions is structured or unstructured. The workflow portion is executed as structured based on the message when the workflow portion is determined to be structured, to produce a structured response. The workflow portion is executed as unstructured based on the message, a task description and a list of structured parameters to be captured, when the workflow portion is determined to be unstructured, to produce an unstructured response via a generative artificial intelligence model.

### BRIEF DESCRIPTION OF THE DRAWINGS

FIG. 1 shows a block diagram of a system for unstructured data collection for generating structured workflows, according to an embodiment.

FIGS. 2A-1, 2A-2, 2B-1, 2B-2, 3A-1, 3A-2, 3B-1, 3B-2, and 4 show an example of a no-code user interface, according to an embodiment.

FIG. 5 is a flowchart that shows a process for collecting unstructured data and generating structured workflows, according to an embodiment.

FIG. 6 is a flowchart that shows a process for executing at least one structured workflow portion and at least one unstructured workflow portion, according to an embodiment.

FIG. 7 is a flowchart that shows a process for providing a no-code user interface by which a group of workflow portions can be defined, according to an embodiment.

FIG. 8 is a flowchart that shows a process for executing at least one structured workflow portion and at least one unstructured workflow portion, according to another embodiment.

### DETAILED DESCRIPTION

One or more embodiments described herein can use a Large Language Model (LLM), combined with prompt engineering, to extract data relevant to a conversation (also referred to herein as data points or conversationally key data points) to be used later in a structured workflow or business process. For example, when shopping for flights, an assistant typically captures origin, destination, departure date, if it's a round trip, potentially preferred airlines, and the number of passengers. Using one or more embodiments, a conversation designer can define data points (e.g., the required and optional data points) to extract, along with a description of the task (e.g., shopping for flights). The one or more embodiments can handle the extraction of that structured information through an unstructured/unscripted conversation with the user. The one or more embodiments can abstract the software engineering complexity through a no-code user interface that provides the ability to define the process for extracting complex information during a (potentially multi-turn) conversation between a human and an AI assistant in a way that humans naturally interact. In short, in contrast to known processes that use rigid, multi-step/node data capture workflows, one or more embodiments use a single step/node that is highly flexible and capable of capturing the same structured parameters as the structured workflow with incredible ease and in an unscripted manner, allowing for fluid human-like conversation.

In this context, the term “workflow” refers to, for example, a sequence of steps involved in moving from the beginning of a business process to the end of the business process. A workflow can also considered, for example, as orchestrated and repeatable patterns of activity that provide a service(s) and/or process information. Such a workflow can be, for example, modeled on or similar to a conversation between a consumer and an assistant seeking information from the consumer to complete a transaction. Such a workflow can have structured workflow portions and an unstructured workflow portion(s).

In this context, the term “structured” refers to, for example, a standardized (or predefined) format that is typically easy for humans and software to access. For example, structured logic can refer to predefined rules that use data (e.g., input data) in a predictable or structured format to produce output (e.g., output data) in a predictable or structured format based on the predefined rules. A structured workflow portion can, for example, refer to a portion of a workflow that receives predictable (e.g., predefined) input such as input data in a predictable or structured format to produce output such as output data in a predictable or structured format (also referred to herein as a “structured response”). The term “unstructured” refers to, for example, a non-standardized (or not predefined) format that can be difficult for software to access or process. For example, unstructured logic can refer to a process lacking predefined rules such an artificial intelligence (AI)/machine learning (ML) model like a large language model (LLM) that can receive prompts that are unpredictable and output data in response to those prompts. Such unstructured logic can be well suited to carry unscripted conversations between humans and an AI assistant; the resulting output of such unscripted conversations can be unstructured and non-deterministic. An unstructured workflow portion can, for example, refer to a portion of a workflow that receives unpredictable (e.g., not predefined) input such as input data in an unpredictable or unstructured format to produce output such as output data in an unpredictable (e.g., unscripted) or unstructured format (also referred to herein as an “unstructured response”).

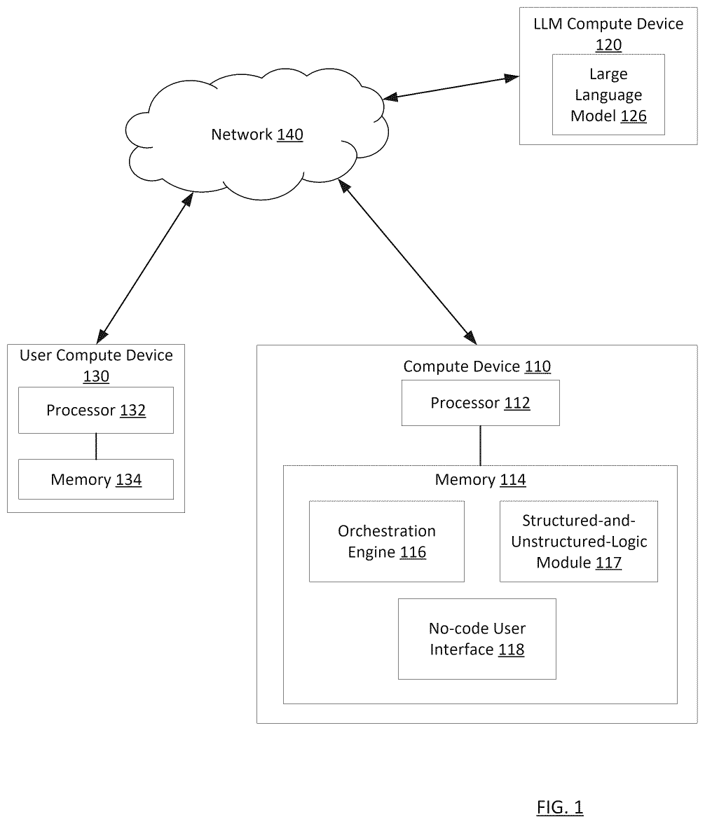

FIG. 1 shows a block diagram of a system for unstructured data collection for generating structured workflows, according to an embodiment. As shown in FIG. 1, compute device 110, LLM compute device 120 and user compute device 130 are interconnected by network 140.

The compute device 110 can include, for example, a processor 112, a memory 114, and a communications interface (not shown). Processor 112 can be coupled to memory 114, and the communications interface. The processor 112 (e.g., a central processing unit (CPU), a graphics processing unit (GPU), and/or the like) can be, for example, a hardware-based integrated circuit (IC) or any other suitable processing device configured to run or execute a set of instructions or codes. The memory 114 (e.g., a random-access memory (RAM), a hard drive, a flash drive, and/or the like) of compute device 110 can store data, and/or code that includes instructions to cause the processor 112 to perform one or more processes or functions. For example, memory 114 includes orchestration engine 116 (also referred to as a natural language understanding engine), structured-and-unstructured-logic module 117 and no-code user interface 118, which can be executed by the processor 112 to perform the one or more processes or functions of the orchestration engine 116, structured-and-unstructured-logic module 117 and no-code user interface 118.

More specifically, the no-code interface 118 can receive input from a user (such as a “conversation designer”) to define the overall workflow, which can include one more structured portions and/or one or more unstructured portions, which use a textual task description and a list of structured parameters described in more detail below. The compute device 110 can receive input (e.g., representing the workflow) via the no-code user interface 118 and in the form for example of a textual task description and a list of structured parameters (e.g., required parameters as well as zero or more optional parameters) that are used later by the structured-and-unstructured-logic module 117 and by the large language model 126 of LLM compute device 120, eliminating (or at least reducing) custom software engineering work. The textual task description is text that describes, for example, the task to be performed by the large language model 126 of LLM compute device 120. An example of a textual task description is “You are tasked with collecting the necessary parameters for booking a trip. Be concise and professional.” In this context, the term “parameter” can be, for example, a value that can relate to or be associated with a task(s) from the textual task description (e.g., a text-based value that indicates “Hawaii” as related to location, a number-based value that indicates “6” as related to a maximum flight duration in hours, a combination of text-based values and number-based values, etc.).

Orchestration engine 116 is responsible for determining when the generative task has been completed by the large language model 126 of LLM compute device 120. The orchestration engine 116 is also responsible for maintaining (configured to maintain) state information (also referred to herein as “state”) during the conversation (also referred to herein as a “session” or “interaction”) between a user (e.g., associated with user compute device 130) and large language model 126. In this context, state information can be, for example, information stored in memory and about events or user interactions at intermediate times or steps within the executed a workflow (e.g., after the execution of each workflow portion within the workflow). The orchestration engine 116 is also responsible for injecting relevant information into the LLM workload of the large language model 126. The structured-and-unstructured-logic module 117 manages the intermix of structured logic (e.g., rules) and unstructured logic (e.g., AI/generative AI). More specifically, the structured-and-unstructured-logic module 117 can cause a switch between structured workflow/business logic to a LLM/AI-powered task(s) and returning to the structured logic once the required structured parameters have been captured by the LLM.

The LLM compute device 120 can include, for example, a processor 122, a memory 124, and a communications interface (not shown). Processor 122 can be coupled to memory 124, and the communications interface. Processor 122, memory 124, and the communications interface of LLM compute device 120 can be similar to the processor 112, memory 114 and the communications interface of compute device 110. The memory 124 (e.g., a random-access memory (RAM), a hard drive, a flash drive, and/or the like) of LLM compute device 120 can store data, and/or code that includes instructions to cause the processor 122 to perform one or more processes or functions. For example, memory 124 includes large language model 126, which can be executed by the processor 122 to perform the one or more processes or functions of the large language model 126. The large language model 126 can carry an unscripted conversation with a user (e.g., a user associated with user compute device 130) and extract structured parameters/user inputs from the unscripted conversation.

The user compute device 130 can include, for example, a processor 132, a memory 134, and a communications interface (not shown). Processor 132 can be coupled to memory 134, and the communications interface. Processor 132, memory 134, and the communications interface of user compute device 130 can be similar to the processor 112, memory 114 and the communications interface of compute device 110. The user compute device 130 can be used, for example, by a user to access the processes and services provided at compute device 110 by engaging in an unscripted conversation with the large language model 126 and the LLM compute device 120.

The communications network 140 can be any suitable communications network for transferring data, operating over public and/or private communications networks. For example, the communications network 140 can include a private network, a Virtual Private Network (VPN), a Multiprotocol Label Switching (MPLS) circuit, the Internet, an intranet, a local area network (LAN), a wide area network (WAN), a metropolitan area network (MAN), a worldwide interoperability for microwave access network (WiMAX®), an optical fiber (or fiber optic)-based network, a Bluetooth® network, a virtual network, and/or any combination thereof. In some instances, the communications network 140 can be a wireless network such as, for example, a Wi-Fi or wireless local area network (“WLAN”), a wireless wide area network (“WWAN”), and/or a cellular network. In other instances, the communications network 140 can be a wired network such as, for example, an Ethernet network, a digital subscription line (“DSL”) network, a broadband network, and/or a fiber-optic network. The communications sent via the communications network 140 can be encrypted or unencrypted. In some instances, the communications network 140 can include multiple networks or subnetworks operatively coupled to one another by, for example, network bridges, routers, switches, gateways and/or the like.

As mentioned above, the compute device 110 can receive input via the no-code user interface 118 and in the form for example of a textual task description and a list of structured parameters (required parameters as well as optional parameters) that are used later by the structured-and-unstructured-logic module 117 and by the large language model 126 of LLM compute device 120. To perform a structured workflow (which in some respects can be similar to known NLP-based workflow systems), the conversation designer (e.g., a human that uses the no-code user interface) can rely on native (pre-defined) slots (e.g., Cities, Countries, FirstNames, Last Names) or create a custom slot/grammar to identify those values for the structured workflow. When the user (e.g., a user associated with user compute device 120) provides an invalid value, the structured process determines how to respond, which provides a linear conversation flow and a robotic experience (e.g., a stilted and unnatural conversational experience). The LLM's general knowledge, however, can be used to extract those values from the user in an unstructured way. The LLM is highly effective at a task(s) involving unstructured variations and is able to conversationally extract the information from the user in a way that would be nearly impossible using solely structured prompts.

Note that although FIG. 1 shows the orchestration engine 116, the structured-and-unstructured-logic module 117 and the no-code user interface 118 as all being located on the same compute device 110, it should be understood that other implementations are possible. For example, in an alternative implementation, the orchestration engine 116 and/or the structured-and-unstructured-logic module 117 can be located at one compute device (e.g., compute device 110) and the no-code user interface 118 can be located at another compute device (e.g., a compute device not shown in FIG. 1). In such an implementation, one entity can control (or own) the compute device where the orchestration engine 116 and/or the structured-and-unstructured-logic module 117 are located, and another entity can control (or own) the compute device where the no-code user interface 118 is located. In yet another implementation where the LLM is not a publicly-accessible resource but instead a private version that is only privately accessible, the LLM compute device 120 may not be used and instead the LLM (e.g., LLM 126) can be located at (accessible at, controlled by) compute device 110 (and/or another compute device not shown in FIG. 1).

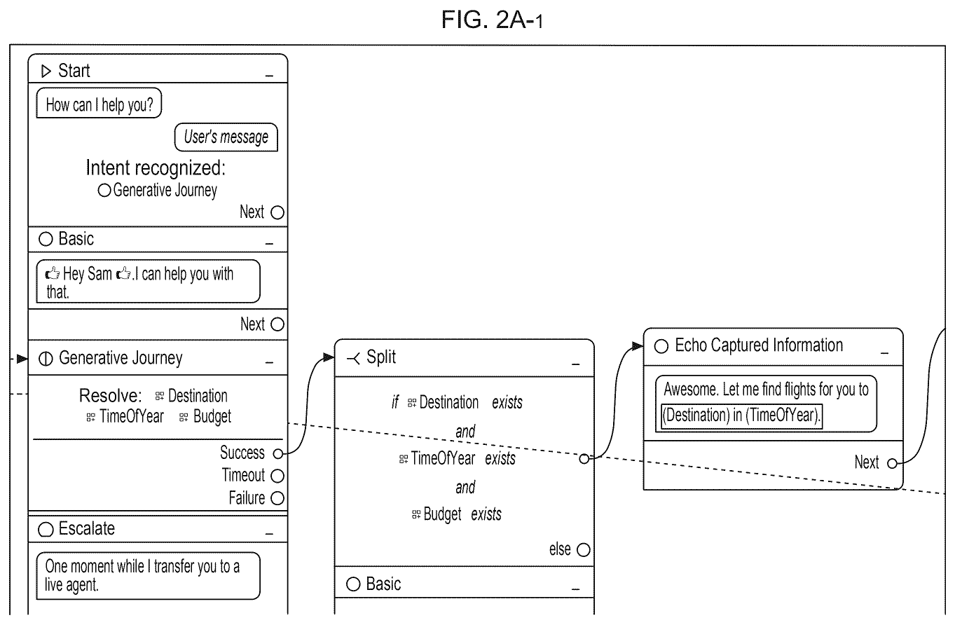

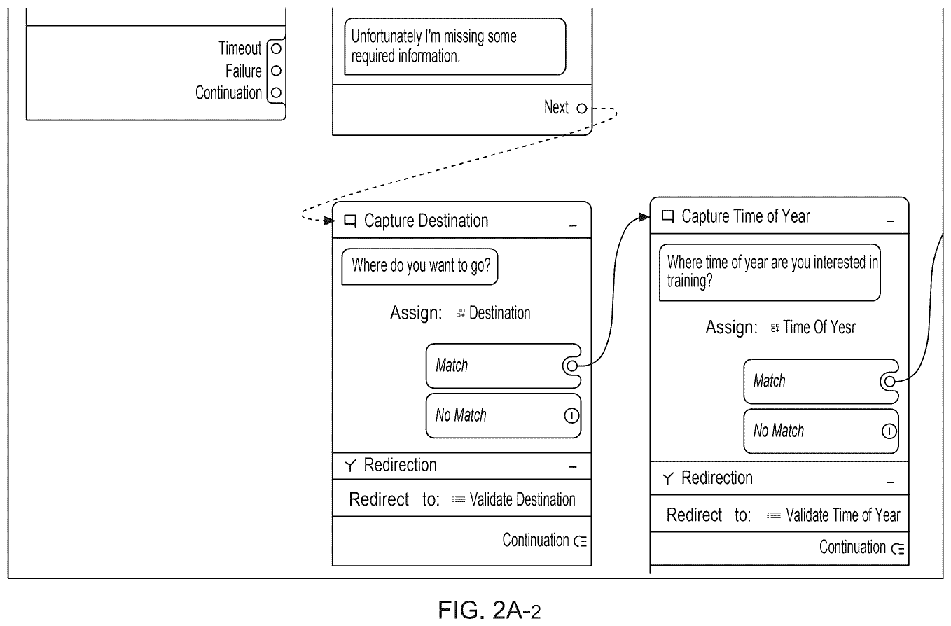

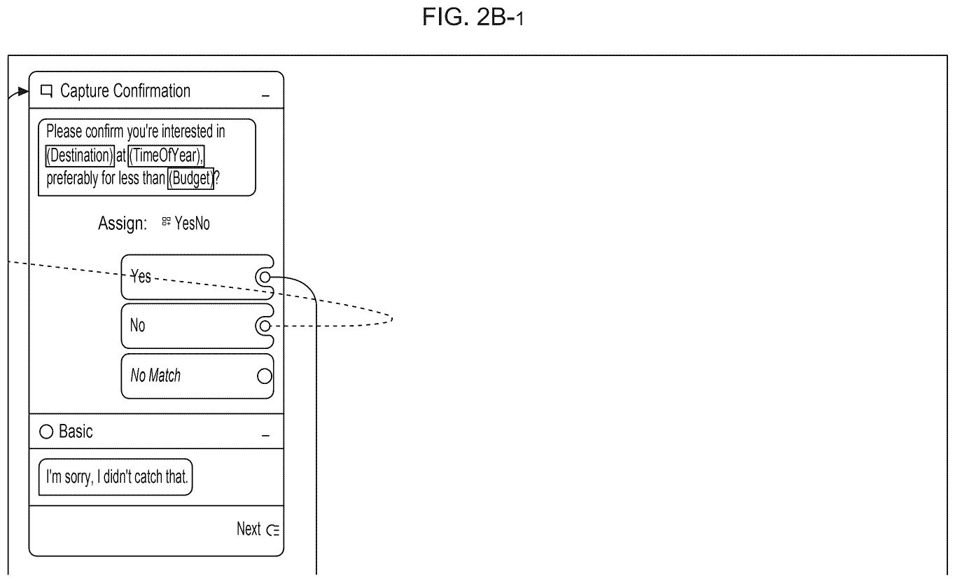

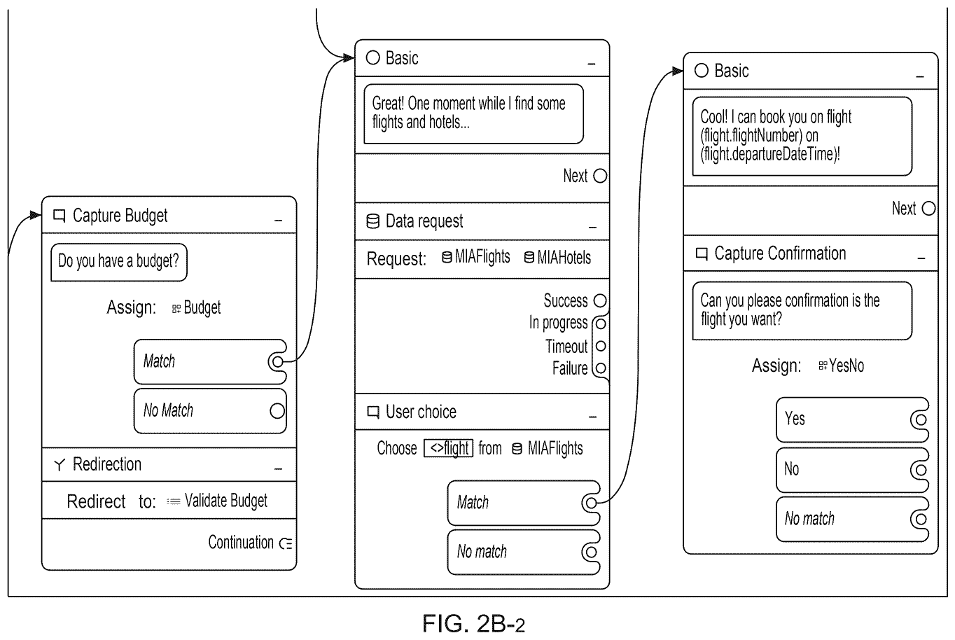

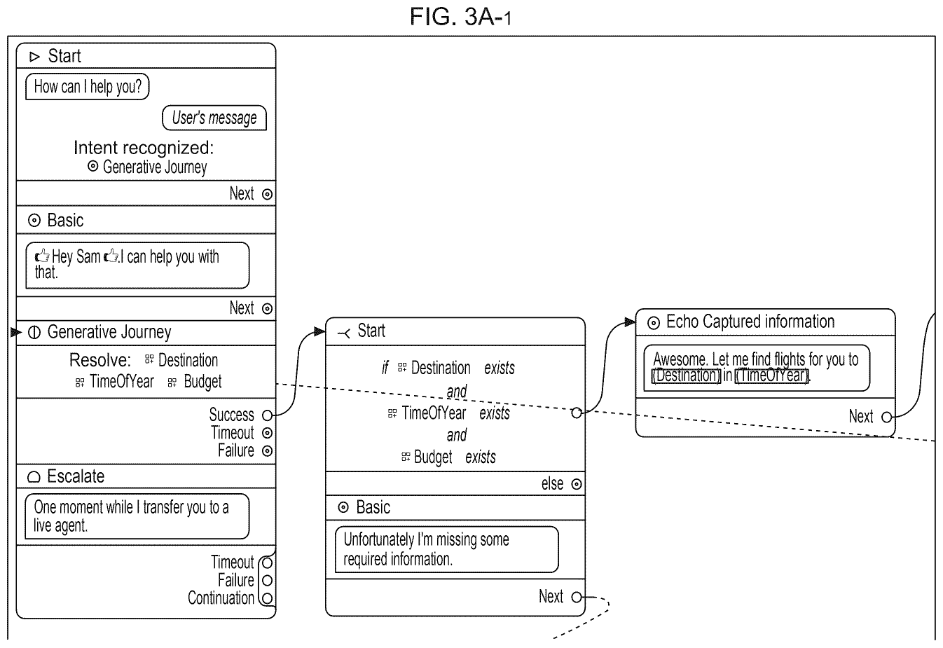

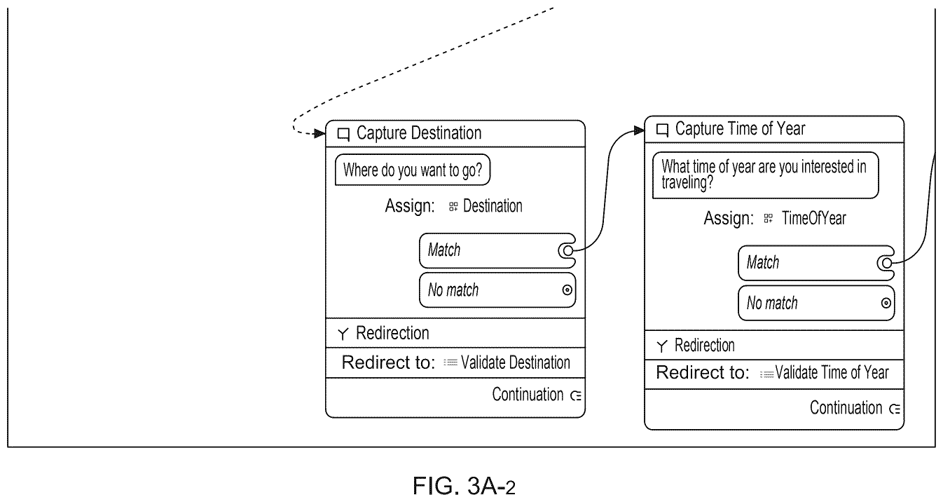

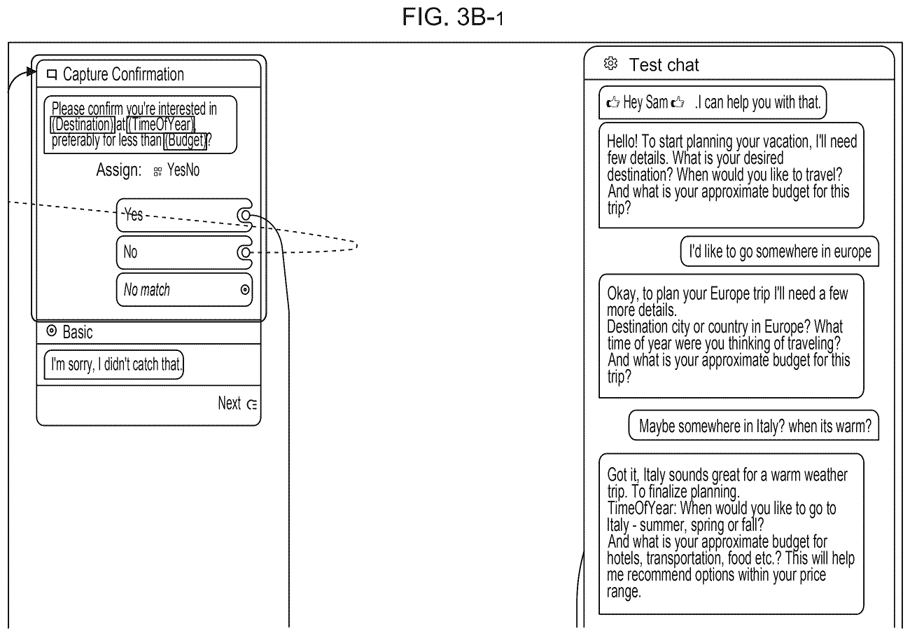

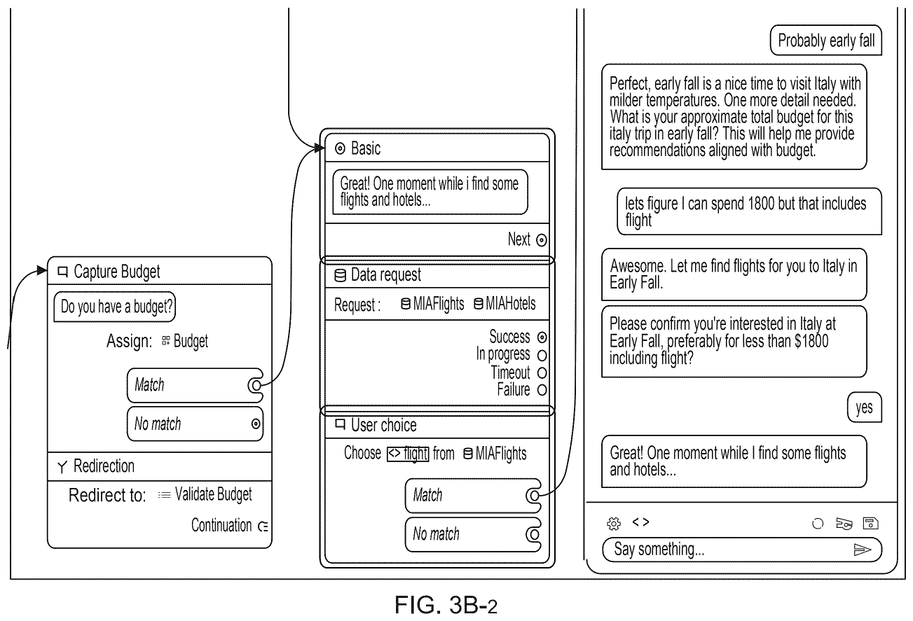

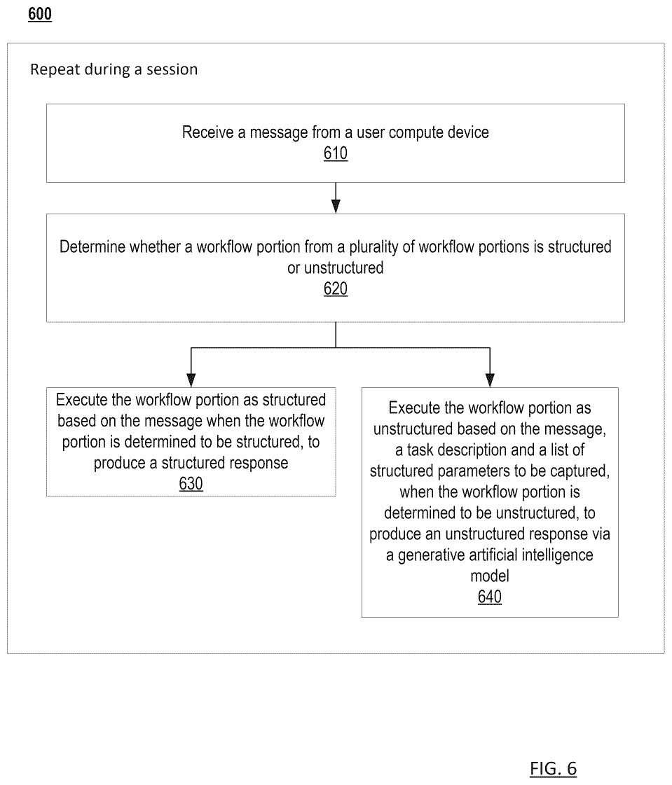

FIGS. 2A-1, 2A-2, 2B-1, 2B-2, 3A-1, 3A-2, 3B-1, 3B-2, and 4 show examples of a no-code user interface, according to an embodiment. As shown in FIGS. 2A-1-4, the no-code user interface allows a conversation designer to select (e.g., drag and drop) boxes with designated function(s), provide text for display to a user, and define logic flow by connecting boxes with directional lines. FIGS. 2A-1-4 can be considered as different stages in time during the process of defining a workflow (designing conversation logic). For example, FIGS. 2A-1, 2A-2, 2B-1 and 2B-2 (the right side of FIGS. 2A-1 and 2A-2 continue into the left side of FIGS. 2B-1 and 2B-2) can represent an initial stage of defining a workflow where various structured portion indicators, unstructured portion indicators and connection indicators have been selected and laid out on a canvas of the no-code user interface, as further discussed in connection with FIG. 6. FIGS. 3A-1, 3A-2, 3B-1 and 3B-2 (the right side of FIGS. 3A-1 and 3A-2 continue into the left side of FIGS. 3B-1 and 3B-2) can include an example of a test chat (shown on the far right side of FIGS. 3B-1 and 3B-2) involving an LLM and based on the process associated with the unstructured portion indicator labeled “Generative Journey”. FIG. 4 can represent a refinement of some the structured portion indicators that have been modified to specific output to a user during a conversation where the user responses did not result in the designated/sought information. For example, the structured portion indicator labeled “Capture Destination” includes a predefined response in the “Basic” portion that specifies the output “I'm sorry. I didn't understand that. Can you try rephrasing the destination you'd like to visit?” Note that the unstructured portion indicators such as the unstructured portion indicator labeled “Generative Journey” does not include a predefined response but rather is based on interactions with the LLM to obtain the designated/sought information (e.g., as defined by a task description and/or a list of structured parameters) through unstructured interactions (e.g., non-predefined interactions).

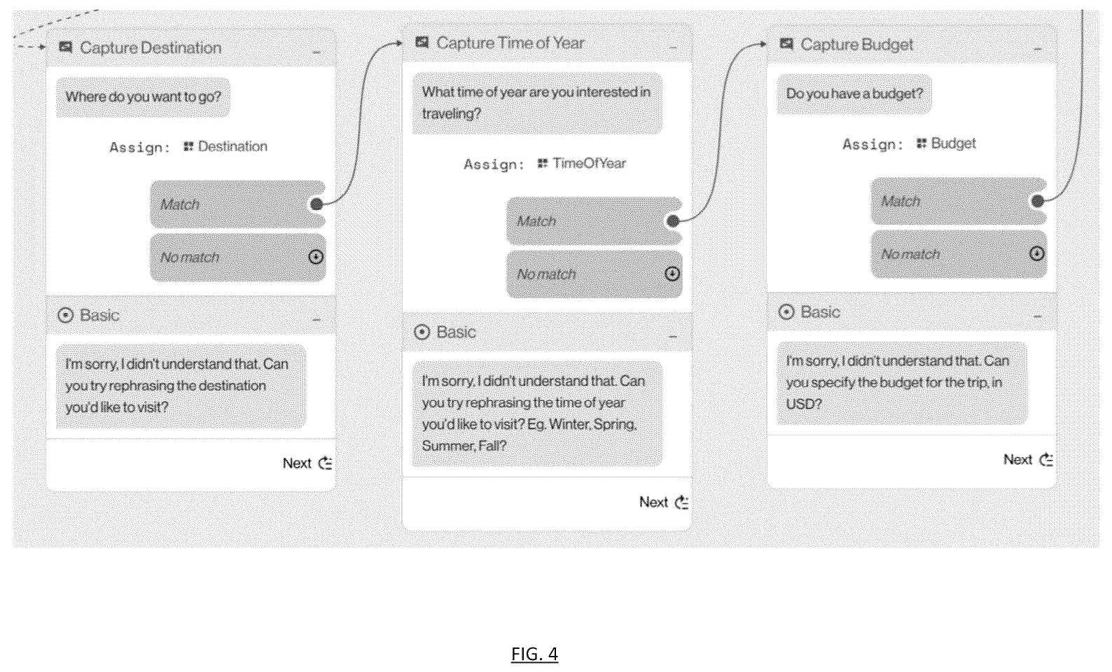

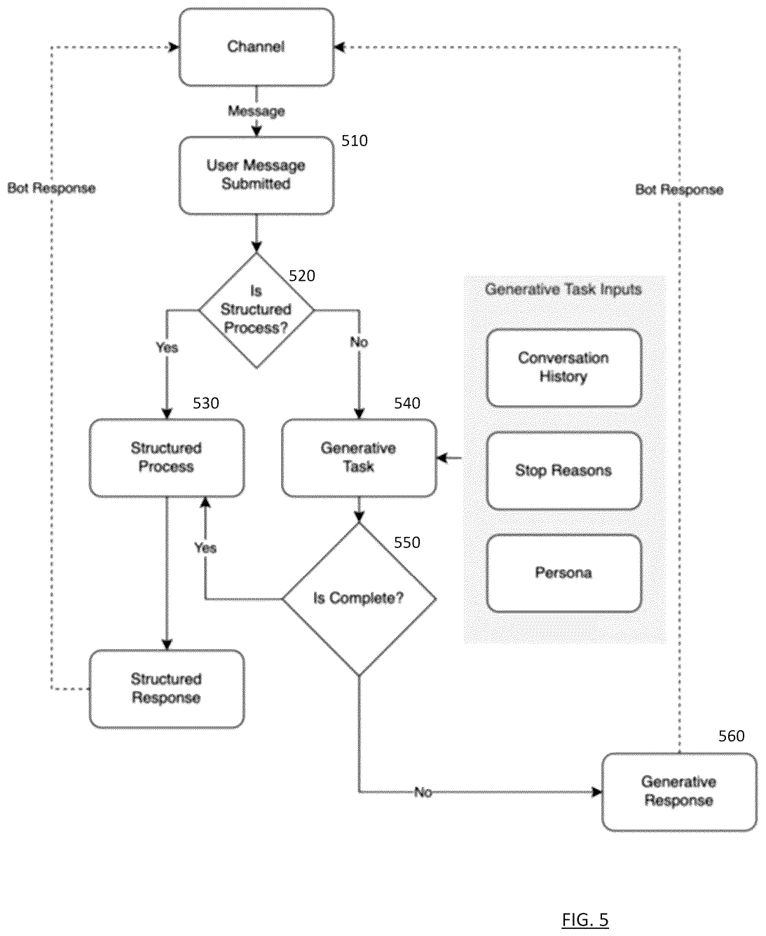

FIG. 5 is a flowchart that shows a process for collecting unstructured data and generating structured workflows, according to an embodiment. In this process, a conversation designer can define a persona and what conditions indicate the generative task is complete. Conversation context is used to fulfill tasks and communicate with the user as influenced by the generative task inputs.

As shown in FIG. 5, at 510, a message from a user via a user compute device (e.g., user compute device 130; not shown in FIG. 5) is received via a communication channel (textual or voice, as an example). At 520, a determination is made as to whether the current state of the conversation workflow (as referred to herein as “workflow”) is structured (e.g., a deterministic business process). If so, then at 530, the orchestration engine (e.g., orchestration engine 116; also referred to as a conversation engine) processes the message through structured logic (e.g., using the structured portion of structured-and-unstructured-logic module 117) and responds with a structured response back to the user via the user compute device.

Returning to 520, if the current state of the workflow is not structured (e.g., and thus is intended to be sent to a Large Language Model (LLM)/Generative AI such as large language model 126), then at 540 the message is sent to the LLM, alongside with generative task inputs (e.g., conversation history up to this point, stop reasons/conditions, persona/user profile information, and other contextual information). At 550, a determination is made as to whether the generative task is complete (e.g., collected a minimum of the required parameters and any number of optional parameters, if applicable). A generative task can be completed, for example, through the interaction of the user (e.g., end user) via the user compute device with the LLM/Generative AI where the user (e.g., end user) provides responses to the conversational cues provided by the LLM/Generative AI. If the generative task is complete, then the workflow resumes to structured logic at 530 and responds with a structured response back to the user via the user compute device. If the generative task is not complete (e.g., the full set of required parameters have not been collected), then at 560 the workflow responds with the generative response (e.g., the output of the LLM/Generative AI). The workflow continues indefinitely, until (i) the user via the user compute device stops sending messages, or (ii) the structured workflow reaches a logical end (end conversation, escalate/transfer conversation to an agent, etc.).

FIG. 6 is a flowchart that shows a process for executing at least one structured workflow portion and at least one unstructured workflow portion, according to an embodiment. As shown in FIG. 6, the method 600 includes repeating 610-640 during a session. In this context, a session can be, for example, an interaction (e.g., a conversation) between a user via a user compute device and the rest of the system (e.g., compute device 110 and LLM compute device 120 of FIG. 1) in which the user via the user compute device provides responses to questions and which involve the execution of workflow portions as the workflow executes through the course of the interaction.

At 610, a message is received from a user compute device. The message can be, for example, received from a user (via user compute device) in the form of text or voice during the course of the conversation. When the message is received from the user in the form of voice, the user compute device can perform a speech recognition function (e.g., speech to text conversation) to create machine readable form of the voice-based message.

At 620, a determination is made as to whether a workflow portion from a group of workflow portions is structured or unstructured. For example, as a conversation involving a user proceeds, different workflow portions will be the next designated for execution based on the overall previously-defined workflow and using the message received at 610. Before such execution occurs, however, a determination is made as to whether that workflow portion is structured or unstructured.

At 630, a workflow portion is executed as structured based on the message, when the workflow portion is determined to be structured, to produce a structured response. A structured response can be, for example, based on/produced by a process that is associated with that workflow portion and that is predefined. At 640, a workflow portion is executed as unstructured based on the message, a task description and a list of structured parameters to be captured, when the workflow portion is determined to be unstructured, to produce an unstructured response via a generative artificial intelligence model. An unstructured response can be, for example, a process that is associated with that workflow portion and that is not predefined and instead can involve an interaction with a large language model (LLM), as described herein. The interaction with the LLM can be based on the message, the task description and the list of structured parameters to be captured by the LLM. For example, the task description and the list of structured parameters can be provided to and used by the LLM to obtain, from the user through the course of the session, information for each structured parameter from the list of structured parameters. This interaction with the LLM can involve multiple interactions with the user in a manner that is not predefined but instead guided by the questions by the LLM the user and the responses received from the user at the LLM.

The process 600 can be repeated until a session is completed pursuant to the previously-defined workflow. For example, the process 600 can be repeated for each workflow portion from the multiple workflow portions of the workflow by performing in each iteration 610, 620, and 630 or 640, and then return to 610 for the next workflow portion within the workflow. Thus, depending on the number and types of workflow portions within the workflow, the process at 630 can be performed one or multiple times and the processor at 640 can be performed one or multiple times at 640.

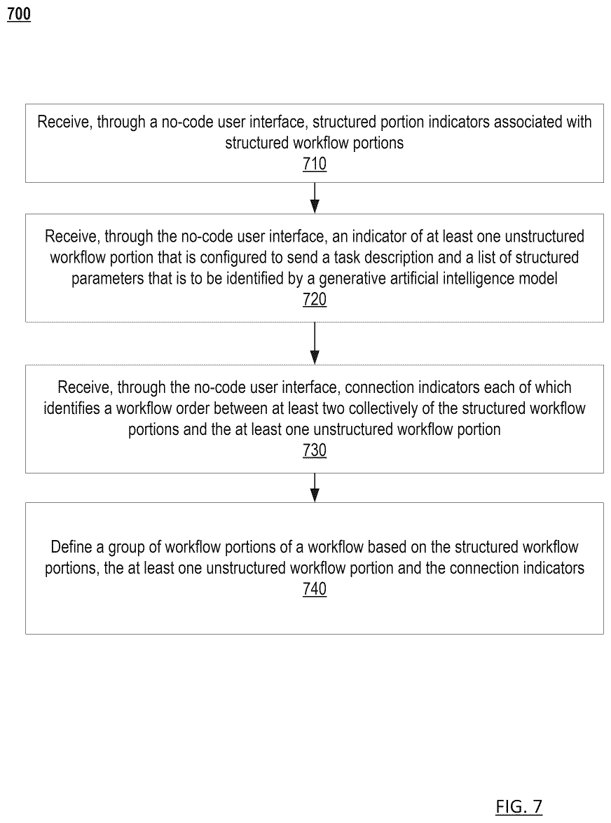

FIG. 7 is a flowchart that shows a process for providing a no-code user interface by which a group of workflow portions can be defined, according to an embodiment. An example of a no-code user interface are shown in FIGS. 2A-1-4. As shown in FIG. 7, the method 700 includes at 710 receiving, through the no-code user interface, structured portion indicators associated with structured workflow portions. For example, FIGS. 2A-1 and 2A-2 and 2B-1 and 2B-2 show multiple examples of structured portion indicators such as the boxes labeled “Split”, “Echo Captured Information”, “Capture Confirmation”, “Capture Destination”, “Capture Time of Year” and “Capture Budget”. These structured portion indicators each can be, for example, selected by a user through a drag-and-drop technique that provides a template on the canvas (displayed background) of the no-code user interface such that the user can then enter specific values into that template of that structured portion indicator. For example, for the structured portion indicator labeled “Split”, a user can enter the text “Unfortunately I'm missing some required information.”

The method 700 also includes at 720 receiving, through the no-code user interface, an indicator of at least one unstructured workflow portion that is configured to send a task description and a list of structured parameters to a generative artificial intelligence (AI) model (such as an LLM) for execution of the generative AI model using the task description and the list of structured parameters to obtained the desired information from the user through interactions between the user and the generative AI model. For example, FIGS. 2A-1 and 2A-2 and 2B-1 and 2B-2 show an example of an unstructured workflow portion as a box labeled “Generative Journey”. This unstructured portion indicator can be, for example, selected by a user through a drag-and-drop technique that provides a template on the canvas (displayed background) of the no-code user interface.

The method 700 also includes at 730 receiving, through the no-code user interface, connection indicators each of which identifies a workflow order and workflow relationships (dependencies) between at least two collectively of the structured workflow portions and the at least one unstructured workflow portion. For example, FIGS. 2A-1 and 2A-2 and 2B-1 and 2B-2 show several examples of connection indicators. For example, a connection indicator with a direction indicator is between the box labeled “Echo Captured Information” and the box labeled “Capture Confirmation” in the direction from the former to the latter. This connection indicator is connected to the box labeled “Echo Captured Information” at a portion labeled “Next”, which indicates that the workflow proceeds from the box labeled “Echo Captured Information” to the box labeled “Capture Confirmation” upon completion of the process associated with the workflow flow of the box labeled “Echo Captured Information”. The workflow portion associated with the box labeled “Capture Confirmation” is dependent on the workflow portion associated with the box labeled “Echo Captured Information” in the sense that the latter is not executed until the former has been executed. For another example, a connection indicator with a direction indicator is between the box labeled “Capture Destination” and the box labeled “Capture Time of Year” in the direction from the former to the latter. This connection indicator is connected to the box labeled “Capture Destination” at a portion labeled “Match”, which indicates that the workflow proceeds from the box labeled “Capture Destination” to the box labeled “Capture Time of Year” upon completion of the process associated with the workflow flow of the box labeled “Capture Destination”. The connection indicators can be, for example, selected by a user through a drag-and-drop technique on to the canvas (displayed background) of the no-code user interface and then modified to connect to the boxes of interest. The workflow portion associated with the box labeled “Capture Destination” is dependent on the workflow portion associated with the box labeled “Capture Time of Year” in the sense that the latter is not executed until the former has been executed.

The structured portion indicators and the unstructured portion indicators are related to (and in some instances may match or used to define) the workflow portions of a workflow. The connector indicators can define the manner and order in which the various workflow portions are executed when a workflow is executed, for example, a conversation (session, interaction) with a user.

Once a workflow has been defined through the no-code user interface, the group of workflow portions that make up the workflow can be accessed and used during a conversation (also referred to as a session or an interaction) with a different user. For example, once a workflow has been defined through the no-code user interface, the representation of the workflow defined through the no-code user interface can be transformed into a different form/format that can be accessed and used more easily during a conversation (also referred to as a session or an interaction) with a different user. Note that the user of the no-code user interface that defines the workflow portions that form a workflow (also referred to as a “conversation designer”) is typically different from the users (also referred to herein as “end users”) that interact with the workflow portions of the workflow during a conversation (session, interaction).

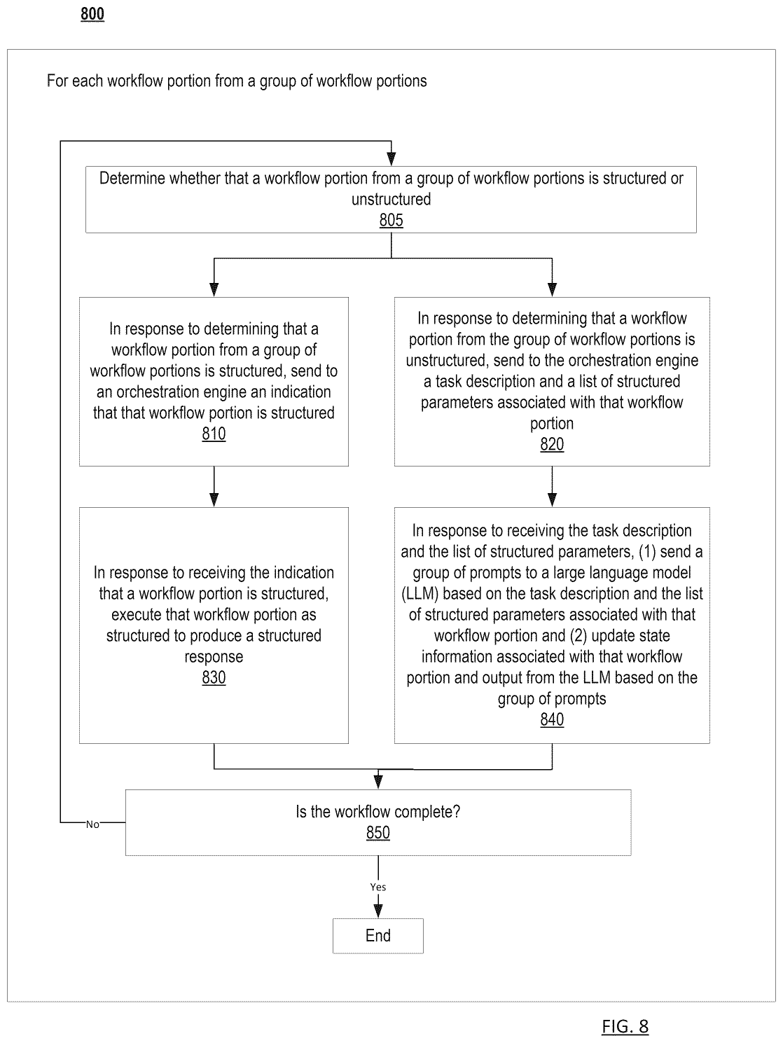

FIG. 8 is a flowchart that shows a process for executing at least one structured workflow portion and at least one unstructured workflow portion, according to another embodiment. As shown in FIG. 8, the method 800 includes repeating 805, 810, 820, 830, 840 and 850 for each workflow portion from a group of workflow portions that define (or are associated with) a workflow. This group of workflow portions can be, for example, associated with a session or interaction (e.g., a conversation) between a user via a user compute device and the rest of the system (e.g., a compute device 110 and LLM compute device 120 of FIG. 1) in which the user provides responses to questions and which involve the execution of workflow portions as the workflow executes through the course of the interaction.

At 805, a determination is made as to whether a workflow portion from the workflow portions is structured or unstructured. If structured, then the process proceeds to 810. If unstructured, then the process proceeds to 820. At 810, in response to determining that a workflow portion from the group of workflow portions is structured, an indication that that workflow portion is structured is sent to an orchestration engine (e.g., orchestration engine 116 of FIG. 1). A structured response can be, for example, a process that is predefined. At 820, in response to determining that a workflow portion is unstructured, a task description and a list of structured parameters associated with that workflow portion is sent to the orchestration engine. An unstructured response can be, for example, a process that is not predefined and instead can involve an interaction with a large language model (LLM) (e.g., large language model 126 of LLM compute device 120 of FIG. 1), as described herein.

The orchestration engine can perform 830 and 840 in response to receiving the indication that a workflow portion is structured and in response to receiving the task description and list of structured parameters, respectively. More specifically, at 830, in response to receiving the indication that a workflow portion is structured, that workflow portion is executed as structured to produce a structured response. At 840, in response to receiving the task description and list of structured parameters, a group of prompts are sent to a large language model (LLM) based on the task description and the list of structured parameters associated with that workflow portion, and state information associated with that workflow portion and associated with output from the LLM based on the group of prompts, is updated. This interaction with between the orchestration engine and the LLM is repeated until the unstructured workflow portion is fully processed as defined by the task description and list of structured parameters.

Once 830 or 840 is complete, the process proceeds to 850 where a determination is made as to whether the workflow is complete, i.e., whether all of the workflow portions from the group of workflow portions for the workflow have been executed. If so, then the process ends. If not, then the process returns to 805 and the process repeats for another iteration until the workflow is complete.

One or more embodiments described herein have several desirable or unique features. For example, an unstructured task that includes a task description and a list of structured parameters to be captured can be assigned to an LLM. For another example, the structured parameters can be separated into required parameters and optional parameters, where the collection of the required parameters is necessary to complete the task and the collection of the optional parameters is conditional to a user providing them. For yet another example, a conversation driven by structured logic can be switched to one driven by an LLM/Generative AI/AI until the required structured parameters are captured, then the conversation driven by the LLM/Generative AI/AI can be switched back to a conversation driven by structured logic. For another example, state can be maintained while switching between structured and unstructured/LLM-driven workflows. For yet another example, the complexity of the software engineering effort can be abstracted to implement a generic, no-code user interface.

One or more embodiments described herein can be used by conversation builders to capture structured inputs from unscripted conversations (e.g., textual, voice, image, video or any other media by which a user can participate in an unscripted conversation) between two parties (e.g., AI or human) with zero programming required. The one or more embodiments can be used to power no-code interactions with extreme agility and minimal required programming (essentially making it trivial to collect structured parameters used to execute a structured workflow and the structured workflow might require API integrations—i.e., send an email—at which point some programming is desirable). The one or more embodiments are agnostic to any use case, and so can be applied to any industry application such as Banking, Insurance, Travel, Hospitality, Tech Support, E-Commerce, etc.

One or more embodiments can reduce the time and effort it takes to capture structured parameters from an unscripted and unstructured conversation between a human and an AI assistant/model/system. Known systems building deterministic workflows to capture the same structured information are limiting and non-comprehensive. In contrast, in the time it takes to manually do all of that, using the one or more embodiments described herein can achieve results significantly faster and more reliably. The one or more embodiments can eliminate the software engineering effort to capture structured parameters from an unscripted, unstructured conversation between a human and an AI assistant/model/system. The one or more embodiments can enable a conversation builder to leverage the true power of LLM/AI to capture structured parameters from unscripted and unstructured conversations, while reverting back to structured business logic once the parameters have been collected.

One or more embodiments abstract the complexity of capturing structured inputs from unstructured conversation between a human user and a computer, reducing the process to providing a descriptive task alongside a list of structured parameters to be collected. Furthermore, the utility of this abstraction is amplified through the use of a no-code interface that can be leveraged to handle any data collection task, regardless of industry, vertical or use case.

Note that an unstructured conversation involving a user (e.g., human user interacting with a computer in the form of an unstructured conversation) can use one or more various forms/types of input and/or output. For example, a user can conduct an unscripted conversation using textual information (e.g., input by a keyboard), voice-based information, an image(s), a video(s) and/or any other applicable media. For example, during an unstructured conversation and in response to the question “where would you like to go”, a user can provide input (via the user compute device) in the form of a screenshot from an app (e.g., a social media app) where the screenshot provides an image or a video of a location. The AI assistant/system can then use that input to identify the information being communicated by the user. For example, if the user responds to the question “where would you like to go” with the screenshot with an image of a location, the AI assistant/system can use image recognition to identify the location and then respond with an indication of the location such as “Oh, Bora Bora! Nice.” Similarly, the AI assistant/system can provide output to the user in the form of textual information, voice-based information, an image(s), a video(s) and/or any other applicable media. For example, if the user responds to the question “where would you like to go” with a text response like “somewhere warm”, the AI assistant/system can provide output to the user in the form of an image of Bora Bora.

All combinations of the foregoing concepts and additional concepts discussed herewithin (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The drawings are primarily for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

The entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. The advantages and features of the application are of a representative sample of embodiments only, and are not exhaustive and/or exclusive. Rather, they are presented to assist in understanding and teach the embodiments, and are not representative of all embodiments. As such, certain aspects of the disclosure have not been discussed herein. That alternate embodiments may not have been presented for a specific portion of the innovations or that further undescribed alternate embodiments may be available for a portion is not to be considered to exclude such alternate embodiments from the scope of the disclosure. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure.

Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure.

The term “automatically” is used herein to modify actions that occur without direct input or prompting by an external source such as a user. Automatically occurring actions can occur periodically, sporadically, in response to a detected event (e.g., a user logging in), or according to a predetermined schedule.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A processor-readable non-transitory medium storing code representing instructions to be executed by a processor, the code comprising code to cause the processor to:
repeat the following during a session with a user compute device:
receive a message from the user compute device;
determine whether a workflow portion from a plurality of workflow portions is structured or unstructured;
execute the workflow portion as structured based on the message when the workflow portion is determined to be structured, to produce a structured response; and
execute the workflow portion as unstructured based on the message, a task description and a list of structured parameters to be captured, when the workflow portion is determined to be unstructured, to produce an unstructured response via a generative artificial intelligence model.

2. The processor-readable non-transitory medium of claim 1, wherein the code further comprises code to cause the processor to:
maintain state while executing the workflow portion as structured and while executing the workflow portion as unstructured.

3. The processor-readable non-transitory medium of claim 1, wherein:
each workflow portion from the plurality of workflow portions is associated with at least one required parameter.

4. The processor-readable non-transitory medium of claim 3, wherein:
each workflow portion from the plurality of workflow portions is further associated with at least one optional parameter.

5. The processor-readable non-transitory medium of claim 1, wherein the plurality of workflow portions is defined in a no-code user interface.

6. The processor-readable non-transitory medium of claim 1, wherein:
the session is a first session,
the generative artificial intelligence model is a large language model (LLM),
the unstructured response produced via the LLM includes a plurality of structured values associated with the list of structured parameters and during a second session between an entity and the LLM, the second session being shorter than the first session.

7. The processor-readable non-transitory medium of claim 1, wherein:
the generative artificial intelligence model is a large language model (LLM), and
the code to execute the workflow portion as unstructured includes code to:
send a plurality of prompts to the LLM based on the task description and the list of structured parameters associated with the workflow portion that is unstructured and that is from the plurality of workflow portions, and
update state information associated with that workflow portion and output from the LLM based on the plurality of prompts.

8. A processor-readable non-transitory medium storing code representing instructions to be executed by a processor, the code comprising code to cause the processor to:
receive, through a no-code user interface, a plurality of structured workflow portion indicators associated with a plurality of structured workflow portions,
receive, through the no-code user interface, an indicator of at least one unstructured workflow portion indicator, the at least one unstructured workflow portion indicator configured to receive a task description and a list of structured parameters that is to be identified by a generative artificial intelligence model,
receive, through the no-code user interface, a plurality of connection indicators, each connection indicator from the plurality of connection indicators identifying a workflow order between at least two collectively of (1) at least one structured workflow portion from the plurality of structured workflow portions or (2) the at least one unstructured workflow portion, and
define a plurality of workflow portions of a workflow based on the plurality of structured workflow portion indicators, the at least one unstructured workflow portion indicator, and the plurality of connection indicators.

9. The processor-readable non-transitory medium of claim 8, wherein:
the code to receive the plurality of structured workflow portion indicators includes code to receive the plurality of structured workflow portion indicators through a drag-and-drop function of the no-code user interface,
the code to receive the indicator of the at least one unstructured workflow portion includes code to receive the indicator of the at least one unstructured workflow portion through the drag-and-drop function of the no-code user interface, and
the code to receive the plurality of connection indicators includes the code to receive the plurality of connection indicators through the drop-and-drop function of the no-code user interface.

10. The processor-readable non-transitory medium of claim 8, wherein the code further comprises code to cause the processor to:
receive a plurality of structured values based on the task description and the list of structured parameters, each structured value from the plurality of structured values being associated with a structured parameter from the plurality of structured parameters.

11. The processor-readable non-transitory medium of claim 8, wherein:
the generative artificial intelligence model is a large language model (LLM), and
the task description indicates a task for completion by the LLM during execution of the at least one unstructured workflow portion, the task description associated with at least one structured value from a plurality of structured values that is obtained during a session by the LLM with an entity and that is associated with the plurality of structured parameters.

12. The processor-readable non-transitory medium of claim 8, wherein:
the generative artificial intelligence model is a large language model (LLM),
the task description listing a plurality of tasks for completion by the LLM during execution of the at least one unstructured workflow portion, each task from the plurality of tasks associated with at least one structured value from a plurality of structured values obtained during a session by the LLM with an entity, the code further comprises code to cause the processor to:
receive, from the LLM, the plurality of structured values in response to the session by the LLM.

13. The processor-readable non-transitory medium of claim 8, wherein:
a connection indicator from the plurality of connection indicators identifies a first workflow order between a structured workflow portion from the plurality of structured workflow portions and an unstructured workflow portion from the at least one unstructured workflow portion,
the first workflow order being the structured workflow portion, then the unstructured workflow portion, and then returning to the structured workflow portion.

14. An apparatus, comprising:
a processor; and
a memory coupled to the processor, the memory storing a structured-and-unstructured-logic module and an orchestration engine,
the structured-and-unstructured-logic module configured to determine, for each workflow portion from the plurality of workflow portions, whether the workflow portion is structured or unstructured,
in response to determining that a workflow portion from the plurality of workflow portions is structured, the structured-and-unstructured-logic module configured to send to the orchestration engine an indication that that workflow portion is structured,
in response to determining that a workflow portion from the plurality of workflow portions is unstructured, the structured-and-unstructured-logic module configured to send to the orchestration engine a task description and a list of structured parameters associated with that workflow portion,
in response to receiving the indication that a workflow portion from the plurality of workflow portions is structured, the orchestration engine configured to execute that workflow portion as structured to produce a structured response,
in response to receiving the task description and the list of structured parameters associated with a workflow portion that is from the plurality of workflow portions and this is unstructured, the orchestration engine configured to (1) send a plurality of prompts to a large language model (LLM) based on the task description and the list of structured parameters associated with that workflow portion and (2) update state information associated with that workflow portion and output from the LLM based on the plurality of prompts.

15. The apparatus of claim 14, wherein the orchestration engine is configured to provide to the LLM each prompt from the plurality of prompts serially until the task description is satisfied and until a plurality of structured values associated with the list of structured parameters is received from the LLM.

16. The apparatus of claim 14, wherein:
the orchestration engine is configured to send the plurality of prompts to the LLM to cause the LLM to send to a user compute device a first plurality of messages associated with the plurality of prompts and to receive from the user compute device a second plurality of messages in response to the first plurality of messages, and
the orchestration engine is configured to receive the second plurality of messages from the LLM, and update the state information based on the second plurality of messages.

17. The apparatus of claim 14, wherein the orchestration engine is configured to, for each prompt from the plurality of prompts, (1) define that prompt based on the task description, the list of structured parameters and the state information at a first time, (2) send that prompt to the LLM and receive a response from the LLM based on that prompt and at a second time after the first time, and (3) update the state information at a third time after the second time based on the response for that prompt.

18. The apparatus of claim 14, wherein the orchestration engine is configured to iteratively repeat the following until the task description is satisfied by the LLM:
(1) define a prompt from the plurality of based on the task description, any applicable prior response from the LLM, the list of structured parameters and the state information at that time,
(2) send that prompt to the LLM and receive a response from the LLM based on that prompt,
(3) update the state information at that time based on the response for that prompt,
(4) in response to the response satisfying the task description, ending the iteration and sending to the structured-and-unstructured-logic module a plurality of structured values associated with the list of structured parameters and based on the response and the any applicable prior responses from the LLM.

19. The apparatus of claim 14, wherein the memory further storing a no-code user interface, the no-code user interface configured to receive a plurality of workflow portion indicators associated with the plurality of workflow portions before execution of the structured-and-unstructured-logic module and the orchestration engine with respect to the plurality of workflow portions.

20. The apparatus of claim 14, wherein:
the memory further storing a no-code user interface,
the no-code user interface configured to receive (1) a plurality of structured workflow portion indicators associated with the plurality of workflow portions, (2) an indicator of at least one unstructured workflow portion associated with the plurality of workflow portions, and (3) a plurality of connection indicators associated with the plurality of structured workflow portion indicators and the indicator of the at least one unstructured workflow portion,
the no-code user interface configured to define the plurality of workflow portions based on the plurality of structured workflow portion indicators, the indicator of the at least one unstructured workflow portion, and the plurality of connection indicators,
the no-code user interface configured to define the plurality of workflow portions before execution of the structured-and-unstructured-logic module and the orchestration engine with respect to the plurality of workflow portions.
